(19) United States
(12) Patent Application Publication
(10) Pub. No.: US 2011/0021251 A1
(43) Pub. Date: Jan. 27, 2011

(54) ELECTRONIC DEVICE WITH TOUCH-SENSITIVE CONTROL

(75) Inventor: Johan T. Lindén, Lund (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 12/507,467

(22) Filed: Jul. 22, 2009

(51) Int. Cl. H04M 1/00

(52) U.S. Cl. 455/566; 345/173

(57) ABSTRACT

A user input device on a surface of the phone different than the surface which a user views information displayed on a display thereof. For example, an electronic device, such as a mobile phone, can have a display on a front side and a user input device such as a touchpad on a backside. The mobile phone can be cradled in a user's palm while being securely grasped on edges thereof by the thumb and forefingers of the user's hand. The touchpad, being located on the backside of the device, can be operated by a user's index finger, for example. Accordingly, the mobile phone can be more securely grasped by the user during operation, and the user's fingers and/or thumb do not obstruct the user's view of the display during operation.

### TECHNICAL FIELD OF THE INVENTION

The present invention relates generally to electronic equipment and, more particularly, to an input device and method for an electronic device.

### DESCRIPTION OF THE RELATED ART

Conventional mobile phones, in addition to providing voice communication capabilities, also provide a number of non-voice related features. For example, mobile phones can be used to surf the internet, transmit and receive messages (e.g., emails and text messages), play music and videos, take and display photographs, as well as a number of other features. Some mobile phones, often referred to as “Smart Phones,” provide many of the same functions as a personal computer.

To effect most features of a mobile phone, a user typical types on a keypad on the face of the phone that is operable to navigate through a graphical user interface of the phone to place and receive calls, send and receive text messages and/or email, play music and/or video, take and display photographs, etc. Some mobile phones have touch-sensitive displays (e.g., touchscreens) wherein a user touches the surface of the screen in the region of an item displayed on the screen in order to select such item.

### SUMMARY

The present invention provides user input device on a surface of the phone opposite the surface that a user views information displayed on a display screen of the device. For example, an electronic device, such as a mobile phone, can have a display on a front side and a user input device such as a touchpad on a backside. The mobile phone can be cradled in a user's palm while being securely grasped on edges thereof by the thumb and forefingers of the user's hand. The touchpad, being located on the backside of the device, can be operated by a user's index finger, for example. Accordingly, the mobile phone can be more securely grasped by the user during operation, and the user's fingers and/or thumb do not obstruct the user's view of the display during operation.

One aspect of the technology relates to an electronic device comprising a display screen for displaying an image for viewing by a user on a first side of the device, a touch sensitive input device on a second side of the device for inputting data to the electronic device, and a controller operatively configured in order that activation of the touch-sensitive input device on the second side of the device generates an effect displayable on the display screen on the first side of the device, wherein the display screen is at least partially transparent whereby a user can view activation of the touch sensitive input device on the second side of the device through the display screen from the first side of the device.

According to another aspect, the second side is opposite the first side.

According to another aspect, the display screen and the touch-sensitive display device are coextensive on their respective opposite sides of the electronic device.

According to another aspect, the areal extent of the display screen and the touch-sensitive display are different.

According to another aspect, the generated effect includes selection of an item displayed on the display screen.

According to another aspect, the generated effect controls a position of an indicator displayable on the display screen, whereby movement on the touch-sensitive input device corresponds to movement of the indicator on the display screen.

According to another aspect, the touch-sensitive input device is responsive to at least two levels of pressure applied to a surface thereof.

According to another aspect, selection of an object displayed on the display screen is effected through an input device other than the touch-sensitive input device on the second side of the electronic device, whereby the touch-sensitive input device is utilized to highlight said object to be selected.

According to another aspect, the touch-sensitive input device includes a touchpad.

According to another aspect, the touch-sensitive input device includes a touchscreen.

According to another aspect, the touch-sensitive input device and the display screen are aligned on the opposite faces such that activation of the touch-sensitive device at a given point overlapping the display screen generates an effect displayable on the display at a corresponding location on the front side of the device.

According to another aspect, the electronic device is a mobile phone.

According to another aspect, the electronic device is at least one of a personal audio device, a personal video device or a personal digital assistant.

According to another aspect, the device further comprises a lockout device for disabling the touch-sensitive input device when not in use.

According to another aspect, the lockout device includes at least one lockout terminal configured to detect contact by a user, and whereby the lockout device is configured to enable the touch-sensitive input device upon detection of contact by a user.

Another aspect of the invention relates to an electronic device comprising a display screen for displaying an image for viewing by a user on a first side of the device, a touch sensitive input device on a second side of the device for inputting data to the electronic device, and a controller operatively configured in order that activation of the touch-sensitive input device on the second side of the device generates an effect displayable on the display screen on the first side of the device, wherein the display screen and the touch sensitive input device are coextensive on respective sides of the electronic device.

Another aspect of the technology includes a method of inputting data to an electronic device comprising activating a touch-sensitive input device on a back surface of the electronic device, generating an effect in response to the activating, and displaying the effect on a display screen on a front surface of the electronic device.

According to another aspect, the method further comprises displaying an object on the display screen in a prescribed location, and selecting the item by activating the touch-sensitive input device in a corresponding location.

According to another aspect, the generating an effect includes moving an indicator displayed on the display screen.

To the accomplishment of the foregoing and the related ends, the invention, then, comprises the features hereinafter fully described in the specification and particularly pointed out in the claims, the following description and the annexed drawings setting forth in detail certain illustrative embodiments of the invention, these being indicative, however, of but several of the various ways in which the principles of the invention may be suitably employed.

Other systems, methods, features, and advantages of the invention will be or become apparent to one with skill in the art upon examination of the following drawings and detailed description. It is intended that all such additional systems, methods, features, and advantages be included within this description, be within the scope of the present invention, and be protected by the accompanying claims.

Although the invention is shown and described with respect to one or more embodiments, it is to be understood that equivalents and modifications will occur to others skilled in the art upon the reading and understanding of the specification. The present invention includes all such equivalents and modifications, and is limited only by the scope of the claims.

Also, although the various features are described and are illustrated in respective drawings/embodiments, it will be appreciated that features of a given drawing or embodiment may be used in one or more other drawings or embodiments of the invention.

It should be emphasized that the term “comprise/comprising” when used in this specification is taken to specify the presence of stated features, integers, steps or components but does not preclude the presence or addition of one or more other features, integers, steps, components or groups thereof.”

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Likewise, elements and features depicted in one drawing may be combined with elements and features depicted in additional drawings. Moreover, in the drawings, like reference numerals designate corresponding parts throughout the several views.

FIG. 1 is an illustration of a prior art mobile phone.

FIG. 2 is an illustration of another prior art phone.

FIG. 3 is an illustration of an exemplary mobile phone in accordance with the invention.

FIG. 4a is an illustration of the front surface of the mobile phone of FIG. 3.

FIG. 4b is an illustration of the back surface of the mobile phone of FIG. 3.

FIG. 5a is an illustration of another exemplary mobile phone in accordance with the invention.

FIG. 5b is an illustration of the mobile phone of FIG. 5a in an open position.

FIG. 6a is an illustration of a front surface of another exemplary mobile phone in accordance with the invention.

FIG. 6b is an illustration of a back surface of the mobile phone of FIG. 6a.

FIG. 7 is an illustration of an exemplary mobile phone displaying an indicator in a first position on a display thereof in accordance with the invention.

FIG. 8 is an illustration of the mobile phone of FIG. 8 with the indicator displayed in a second position on the display.

FIG. 9 is a functional block diagram of an exemplary mobile phone in accordance with the invention.

### DETAILED DESCRIPTION OF EMBODIMENTS

The present invention will now be described with reference to the drawings, wherein like reference numerals are used to refer to like elements throughout.

The term “electronic equipment” and/or “electronic device” includes portable radio communication equipment. The term “portable radio communication equipment,” which herein after is referred to as a “mobile radio terminal,” “mobile phone,” “mobile device,” or “mobile terminal”, and the like, includes all equipment such as mobile telephones, pagers, communicators, i.e., electronic organizers, personal digital assistants (PDAs), smartphones, portable communication apparatus or the like.

In the present application, the invention is described primarily in the context of a mobile phone. However, it will be appreciated that the invention is not intended to be limited to a mobile phone and can be any type of electronic equipment. As will be appreciated, the invention may be applicable to both portable devices (e.g., hand held mobile phones) and non-portable devices.

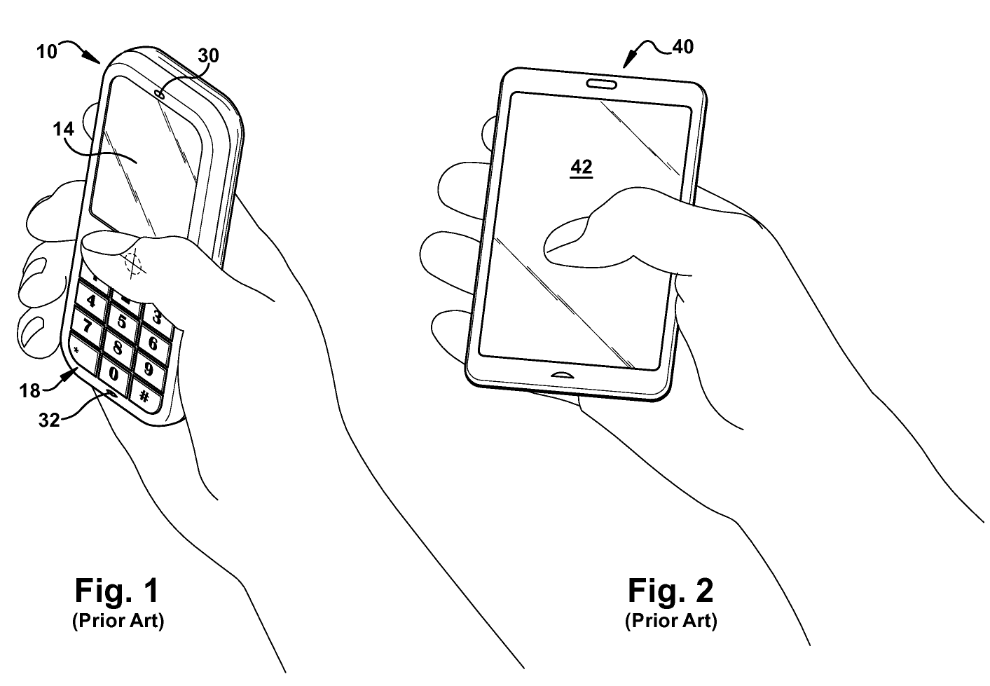

Referring initially to FIGS. 1 and 2, two types of prior art mobile phone designs are illustrated. In FIG. 1, the mobile phone 10 has a “brick” or “block” form factor housing. The mobile telephone 10 includes a display 14. The display 14 displays information to a user such as operating state, time, telephone numbers, contact information, various navigational menus, etc., which enable the user to utilize the various features of the mobile telephone 10. The display 14 also may be used to visually display content received by the mobile telephone 10 and/or retrieved from a memory of the mobile telephone 10. The display 14 may be used to present images, video and other graphics to the user, such as photographs, mobile television content and video associated with games.

A keypad 18 provides for a variety of user input operations. For example, the keypad 18 typically includes alphanumeric keys for allowing entry of alphanumeric information such as telephone numbers, phone lists, contact information, notes, etc., when such keys are physically depressed. In addition, the keypad 18 typically includes special function keys such as a “call send” key for initiating or answering a call, and a “call end” key for ending or “hanging up” a call. Special function keys also may include menu navigation and select keys to facilitate navigating through a menu displayed on the display 14. For instance, a pointing device and/or navigation keys may be present to accept directional inputs from a user. Special function keys may include audiovisual content playback keys to start, stop and pause playback, skip or repeat tracks, and so forth. Other keys associated with the mobile telephone may include a volume key, an audio mute key, an on/off power key, a web browser launch key, a camera key, etc. Keys or key-like functionality also may be embodied as a touch screen associated with the display 14. Also, the display 14 and keypad 18 may be used in conjunction with one another to implement soft key functionality.

In FIG. 2, another prior art mobile telephone design is illustrated. This mobile phone 40 does not have a keypad but instead includes a touchscreen 42 that enables a user to both view information displayed thereon and input data to the mobile phone 40 by touching the screen. This type of mobile phone 40 generally offers a larger display screen than a mobile phone like that of FIG. 1 since physical buttons are not necessary for a user to input data.

In operation, both phones are typically cradled in a user's palm as shown in the figures, while the keys of the keypad 18 or the touchscreen 42 are manipulated by the user's thumb. Since the user typically must move the thumb between various keys or different locations on the touchscreen, actively grasping the phone during operation is difficult for many users. This can possibly result in hand fatigue and/or inadvertent dropping of the mobile phone. Further, the thumb or any other finger used to manipulate the keypad 18 or touchscreen 42 may obstruct the user's view of the keypad 18 or touchscreen 42. In the case of the touchscreen, such obstruction can prevent the user from accurately touching a desired position on the touchscreen.

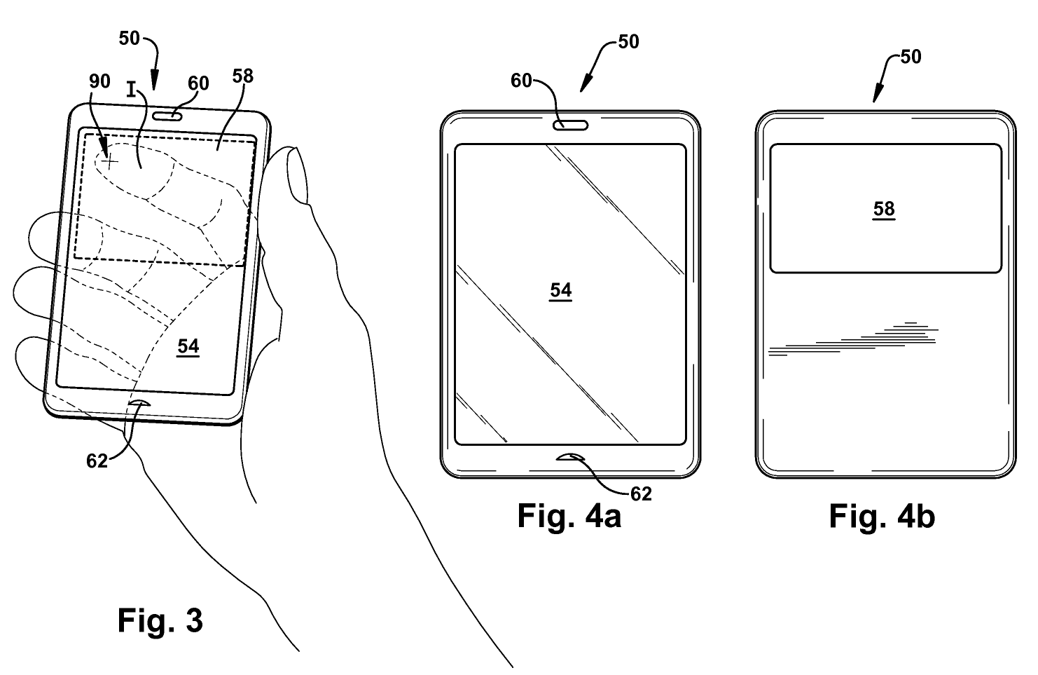

Turning now to FIG. 3, and in accordance with the invention, an exemplary mobile phone 50 is shown having a display screen 54 on a first side (front) and a user input device, in the form of a touchpad 58, on a second side (back) of the phone 50. Providing the touchpad 58 on the back of the mobile phone 50 enables the phone 50 to be positively grasped between the thumb and forefingers of a user while data is input to the mobile phone 50 via one of the user's forefingers such as the index finger I as shown. Further, the display screen 54 remains unobstructed by the user's hand and/or fingers during activation of the touchpad 58 thereby allowing the user to view the entire screen during operation.

In FIGS. 4a and 4b, the front and back sides of the phone 50 are illustrated. As will be appreciated, the front of the phone 50 includes display screen 54, a speaker 60, and a microphone 62. The back side of the phone 50 includes the touchpad 58. The touchpad 58 can be positioned on the back of the phone 50 in a location that allows access by the user's index finger I but is at least somewhat isolated from inadvertent contact by the user's other forefingers and/or palm during operation. Alternatively, the touchpad 58 can essentially comprise the entire back surface of the phone 50 and be essentially coextensive with the display screen 54 on the front of the phone.

The touchpad 58 can be any suitable type of touch-pad such as a resistive-type or capacitive-type touch-pad. As will be appreciated, a wide variable of touch-sensitive technologies exist, any or all of which may be suitable for use in accordance with the invention. In some applications the touch-pad can be part of a touch-screen display.

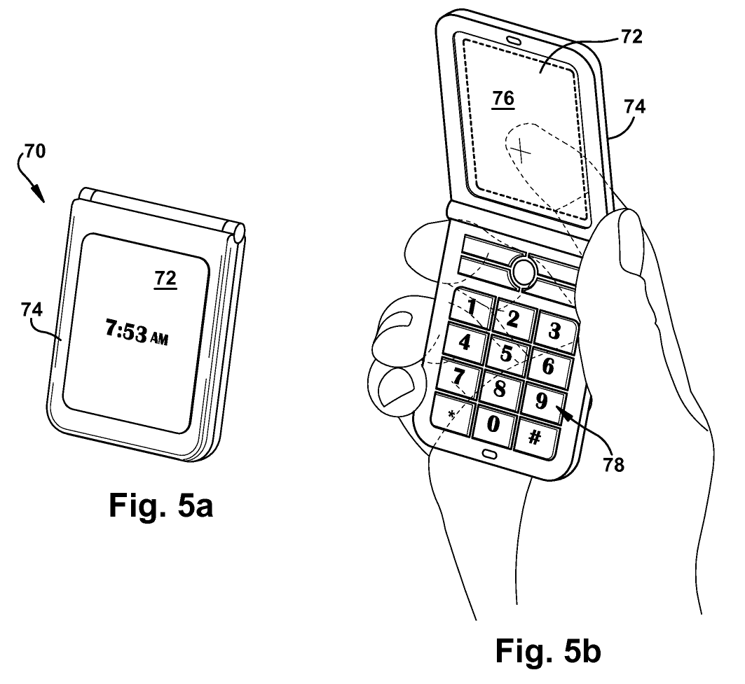

For example, and with reference to FIGS. 5a and 5b, an exemplary mobile phone 70 is illustrated. In this embodiment, the mobile phone 70 is of the flip phone or clam-shell design, and has a touchscreen display 72 on an exterior of an upper portion 74 of the phone mobile 70. Such touchscreen display 72 typically displays information such as the time, missed calls, messages, etc. when the mobile phone 70 is in the closed position shown in FIG. 5a. In a conventional flip phone, when the mobile phone 70 is open as shown in FIG. 5b, the touchscreen display 72 is generally not utilized since a user is instead focused on a main display 76 of the mobile phone 70 adjacent a keypad 78.

In accordance with the invention, however, the touchscreen display 72 can be utilized to input data to the mobile phone 70 in much the same manner as set forth above in connection with FIGS. 3, 4a and 4b. More specifically, when the mobile phone 70 is cradled in a user's palm, the user's index finger I, for example, may be in position to manipulate the touchscreen display 72 which is now on the back side of the mobile phone 70.

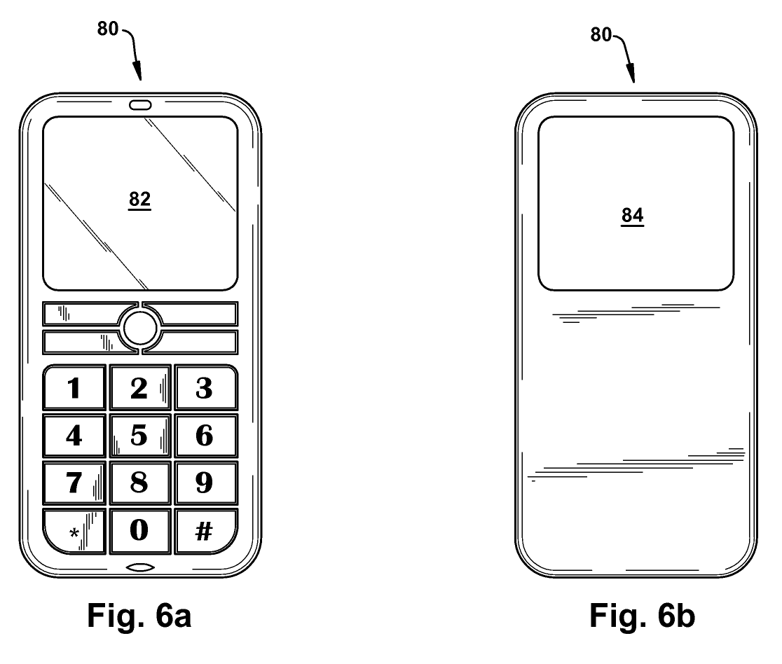

Similarly, and with reference to FIGS. 6a and 6b which illustrate another exemplary phone 80 of the brick design having a main display 82 on a front side and a touch-sensitive surface 84 on a back side, operation of the touch-sensitive display can be performed by a user's forefingers while the phone 80 is cradled in the user's palm.

In the exemplary embodiments of FIGS. 3-6b, it will be appreciated that a suitable manner of indicating the location of a user's finger on the touch sensitive panel may be advantageous given that the input device generally is located out of view of the user during operation. Accordingly, it will be appreciated that devices in accordance with the invention may be configured to display an indicator on the viewing surface (e.g., display screen) to denote the position of the user's finger on the touch-sensitive surface.

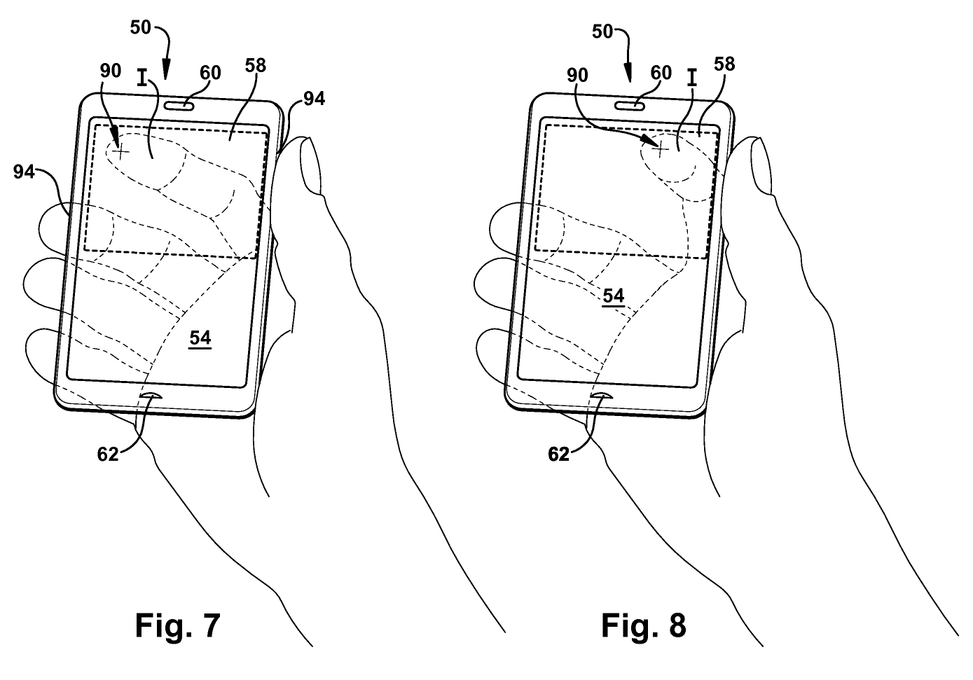

For example, and with reference to FIGS. 7 and 8, the mobile phone 50 of FIG. 3 is illustrated with a user's index finger I in two different positions. An indicator in the form of a crosshair 90 is shown on the display 54. The crosshair 90 corresponds to the location of the user's index finger I on the touch-sensitive surface. As will be appreciated, the crosshair 90 can be configured to track the movement of the user's finger on the display 54. In this manner, a user can navigate between different items displayed on the display 54 in a similar manner to a user interface that utilizes a mouse and a pointer.

Thus, in operation a user may move a finger across the touch-pad 58 to select with the crosshair 90 a given item displayed on the display 54. As the user moves his finger between items, the crosshair 90 tracks movement of the finger and thereby indicates to the user the corresponding selected position on the display screen 54. In order for a user to select an item displayed on the display screen 54, the touchpad can be configured to detect at least two levels of pressure. A first level can correspond to a minimum pressure indicative of a user moving his finger across the touchpad 58 to highlight an item on the display screen 54. A second level of pressure greater than the first can be detected to indicate selection by the user. Alternatively, a separate button or other input could be provided which a user could activate to indicate selection of a highlighted item. As will be appreciated, instead of using a crosshair to indicate a position on the screen, other methods such as highlighting could be used.

Alternatively, some touch-sensitive technologies work simply by proximity. For example, touchscreen panels that employ capacitive technologies generally do not need to be directly touched in order to be activated. Using such technology, a user may simply stroke their finger near the touch-sensitive panel in order to manipulate the indicator displayed on the screen. The user may then directly touch the panel in order to select a given item on the display.

In an alternative embodiment, the display screen can be at least partially transparent so as to permit a user to see through the display screen in order to determine the location at which the user's finger(s) strike the touch-sensitive input device. For example, the touch-sensitive input device can be part of a transparent or semi-transparent touch-screen assembly. In such embodiments, the user's finger(s) may be visible through the display screen such that an indicator need not be displayed on the screen but rather the point of contact of the user's finger(s) can be viewed by the user. The ability of a user to view, from a front side of a mobile phone, his or her fingers interacting with a touch-sensitive input device on a back side of the mobile phone may significantly enhance a user's experience. Of course, an indicator or indicators, as previously described, could also be displayed on the display screen if desired.

Further, it will be appreciated that the touch-sensitive input device 58 may be used for scrolling functions and/or for moving an indicator displayed on the display screen, much as movement of a mouse moves a pointer displayed on a computer monitor. In some embodiments, the touch-sensitive input device 58 on the back of the mobile phone may be limited to such function, with actual selection of an object being performed by touching a touchscreen (or other input) associated with the front side of the device. In this manner, the touch-sensitive input device can be prevented from initiating undesired actions.

By way of example, in the embodiment illustrated in FIGS. 7 and 8, a user may use the touchpad 58 to move the indicator from the position of FIG. 7 to the position of FIG. 8 in order to highlight a desired item, for example a contact in an address book of the mobile phone. To select the contact, the user may then tap on the display screen 54 with the thumb, or depress a button (not shown) provided on the mobile phone 50, as the case may be.

In some embodiments, the touch-sensitive input device can be generally coextensive with the display screen on the opposite side of the device. In other words, each point on the display screen would have a corresponding point on the touch-sensitive input device directly on the opposite side of the device. Thus, a user could select an item displayed on the display screen simply by touching the touch-sensitive input device on the back of the electronic device in the same location, albeit on the on back of the screen. As will be appreciated, by providing an indicator on the display surface as previously described, or utilizing a semi-transparent display screen that allows a user to see his finger(s) through the display screen, more accurate touching of the touch-sensitive input device in the desired location can be facilitated.

It will further be appreciated that in some embodiments it may be desirable to provide a lock-out device to prevent inadvertent activation of the touch-sensitive input device. Accordingly, a suitable lock-out mechanism can be provided such as a button or key that is depressed to lock and unlock the touch-sensitive input device. Alternatively, and with reference back to FIGS. 7 and 8, lockout terminals can be provided along respective sides of the mobile phone 50 in a position whereby upon grasping the mobile phone 50, a user′ thumb and forefingers make contact with the lockout contacts 94. Suitable circuitry can be provided for detecting such contact by the user's thumb and forefingers and for unlocking the touch-sensitive panel in response thereto.

As will be appreciated, the terms touch-sensitive input device, touchpad, etc. as used herein generally refer to technologies that detect the presence and/or location of a touch on a touchable surface of the device. Unlike a keypad having physical keys that are depressed upon application of force by a user, a touch-sensitive input device can be activated merely by touching, or coming within a close proximity to, the touchable surface with a finger or other object such as a stylus.

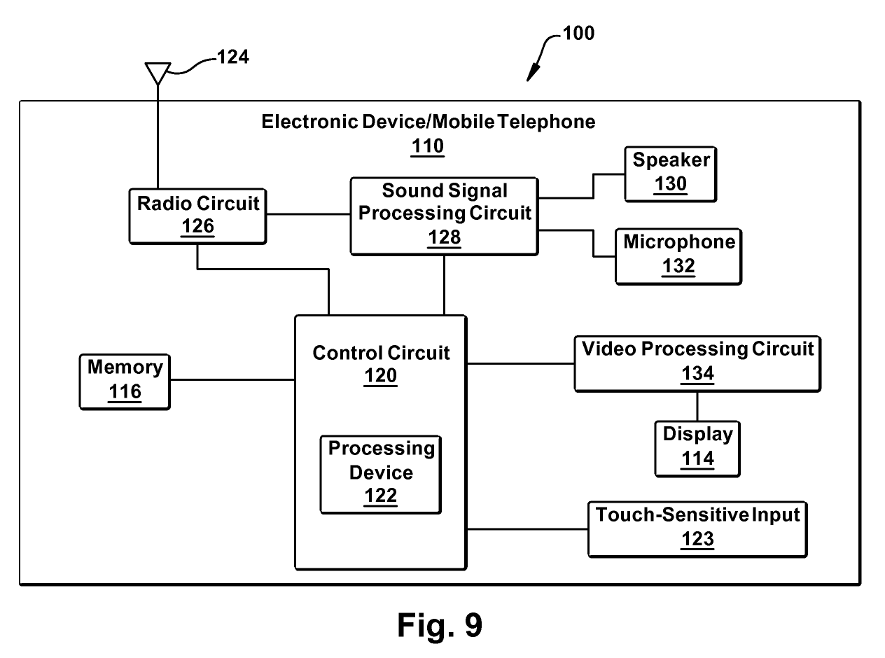

As will also be appreciated, the exemplary mobile phones described above can include circuitry for implementing calls and other various functions. With reference to FIG. 9, a functional block diagram of an exemplary mobile phone 100 is shown. For the sake of brevity, generally conventional features of the mobile telephone 100 will not be described in great detail herein. The mobile telephone 100 includes a primary control circuit 120 that is configured to carry out overall control of the functions and operations of the mobile telephone 100 including the touch-sensitive input features. The control circuit 120 may include a processing device 122, such as a CPU, microcontroller or microprocessor. The processing device 122 executes code stored in a memory (not shown) within the control circuit 20 and/or in a separate memory, such as the memory 116, in order to carry out operation of the mobile telephone 10. The memory 116 may be, for example, one or more of a buffer, a flash memory, a hard drive, a removable media, a volatile memory, a non-volatile memory, a random access memory (RAM), or other suitable device.

In addition, the processing device 122 may execute code to carry out operation of a touch-sensitive input device 123, such as the touchpad or touchscreen described previously. It will be apparent to a person having ordinary skill in the art of computer programming, and specifically in application programming for mobile telephones or other electronic devices, how to program a mobile telephone 100 to operate and carry out logical functions associated with the touch-sensitive input 123. Accordingly, details as to specific programming code have been left out for the sake of brevity. Also, it will be appreciated that the touch-sensitive operations could be carried out via dedicated hardware, firmware, software, or combinations thereof, without departing from the scope of the invention.

Continuing to refer to FIG. 9, the mobile telephone 110 includes an antenna 124 coupled to a radio circuit 126. The radio circuit 126 includes a radio frequency transmitter and receiver for transmitting and receiving signals via the antenna 124 as is conventional. The radio circuit 126 may be configured to operate in a mobile communications system and may be used to send and receive data and/or audiovisual content. Receiver types for interaction with a mobile radio network and/or broadcasting network include, but are not limited to, GSM, CDMA, WCDMA, GPRS, WiFi, WiMax, DVB-H, ISDB-T, etc., as well as advanced versions of these standards.

The mobile telephone 100 further includes a sound signal processing circuit 128 for processing audio signals transmitted by and received from the radio circuit 126. Coupled to the sound processing circuit 128 are a speaker 130 and a microphone 132 that enable a user to listen and speak via the mobile telephone 100 as is conventional. The radio circuit 126 and sound processing circuit 128 are each coupled to the control circuit 120 so as to carry out overall operation. Audio data may be passed from the control circuit 120 to the sound signal processing circuit 128 for playback to the user. The audio data may include, for example, audio data from an audio file stored by the memory 116 and retrieved by the control circuit 120, or received audio data such as in the form of streaming audio data from a mobile radio service. The sound processing circuit 128 may include any appropriate buffers, decoders, amplifiers and so forth.

The display 114 may be coupled to the control circuit 120 by a video processing circuit 134 that converts video data to a video signal used to drive the display 114. The video processing circuit 134 may include any appropriate buffers, decoders, video data processors and so forth. The video data may be generated by the control circuit 120, retrieved from a video file that is stored in the memory 1 16, derived from an incoming video data stream that is received by the radio circuit 128 or obtained by any other suitable method.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. An electronic device comprising:
a display screen for displaying an image for viewing by a user on a first side of the device;
a touch sensitive input device on a second side of the device for inputting data to the electronic device; and
a controller operatively configured in order that activation of the touch-sensitive input device on the second side of the device generates an effect displayable on the display screen on the first side of the device;
wherein the display screen is at least partially transparent whereby a user can view activation of the touch sensitive input device on the second side of the device through the display screen from the first side of the device.

2. An electronic device as set forth in claim 1, wherein the second side is opposite the first side.

3. An electronic device as set forth in claim 1, wherein the display screen and the touch-sensitive display device are coextensive on their respective opposite sides of the electronic device.

4. An electronic device as set forth in claim 1, wherein the areal extent of the display screen and the touch-sensitive display are different.

5. An electronic device as set forth in claim 1, wherein the generated effect includes selection of an item displayed on the display screen.

6. An electronic device as set forth in claim 1, wherein the generated effect controls a position of an indicator displayable on the display screen, whereby movement on the touch-sensitive input device corresponds to movement of the indicator on the display screen.

7. An electronic device as set forth in claim 6, wherein selection of an object displayed on the display screen is effected through an input device other than the touch-sensitive input device on the second side of the electronic device, whereby the touch-sensitive input device is utilized to highlight said object to be selected.

8. An electronic device as set forth in claim 1, wherein the touch-sensitive input device is responsive to at least two levels of pressure applied to a surface thereof.

9. An electronic device as set forth in claim 1, wherein the touch-sensitive input device includes a touchpad.

10. An electronic device as set forth in claim 1, wherein the touch-sensitive input device includes a touchscreen.

11. An electronic device as set forth in claim 1, wherein the touch-sensitive input device and the display screen are aligned on the opposite faces such that activation of the touch-sensitive device at a given point overlapping the display screen generates an effect displayable on the display screen at a corresponding location on the front side of the device.

12. An electronic equipment as set forth in claim 1, wherein the electronic equipment is a mobile phone.

13. An electronic equipment as set forth in claim 1, wherein the electronic equipment is at least one of a personal audio device, a personal video device or a personal digital assistant.

14. An electronic equipment as set forth in claim 1, further comprising a lockout device for disabling the touch-sensitive input device when not in use.

15. An electronic equipment as set forth in claim 14, wherein the lockout device includes at least one lockout terminal configured to detect contact by a user, and whereby the lockout device is configured to enable the touch-sensitive input device upon detection of contact by a user.

16. An electronic device comprising:
a display screen for displaying an image for viewing by a user on a first side of the device;
a touch sensitive input device on a second side of the device for inputting data to the electronic device; and
a controller operatively configured in order that activation of the touch-sensitive input device on the second side of the device generates an effect displayable on the display screen on the first side of the device;
wherein the display screen and the touch sensitive input device are coextensive on respective sides of the electronic device.

17. A method of inputting data to an electronic device comprising:
activating a touch-sensitive input device on a back surface of the electronic device;
generating an effect in response to the activating; and
displaying the effect on a display screen on a front surface of the electronic device.

18. A method as set forth in claim 17, further comprising displaying an object on the display screen in a prescribed location, and selecting the item by activating the touch-sensitive input device in a corresponding location.

19. A method as set forth in claim 17, wherein the generating an effect includes moving an indicator displayed on the display screen.
